(19) United States
(12) Patent Application Publication
(10) Pub. No.: US 2014/0334033 A1
(43) Pub. Date: Nov. 13, 2014

(54) QUASI-STATICALLY ORIENTED HEAD FOR RECORDING NON-LEGACY FORMATS

(71) Applicant: INTERNATIONAL BUSINESS MACHINES CORPORATION, Armonk, NY (US)

(72) Inventors: Robert G. Biskeborn, Hollister, CA (US); Calvin S. Lo, Saratoga, CA (US)

(73) Assignee: International Business Machines Corporation, Armonk, NY (US)

(21) Appl. No.: 13/890,155

(22) Filed: May 8, 2013

(51) Int. Cl. G11B 5/53

(52) U.S. Cl. CPC G11B 5/535
USPC 360/76; 360/134

(57) ABSTRACT

Apparatuses are configured to addresses tape dimensional stability (TDS) via small rotations about the quasi-static tilt angle and read and/or write data in non-legacy formats. Products such as tape media products are also presented.

### BACKGROUND

The present invention relates to data storage systems, and more particularly, this invention relates to a magnetic head and system implementing the same, where the head has offset arrays.

In magnetic storage systems, data is read from and written onto magnetic recording media utilizing magnetic transducers. Data is written on the magnetic recording media by moving a magnetic recording transducer to a position over the media where the data is to be stored. The magnetic recording transducer then generates a magnetic field, which encodes the data into the magnetic media. Data is read from the media by similarly positioning the magnetic read transducer and then sensing the magnetic field of the magnetic media. Read and write operations may be independently synchronized with the movement of the media to ensure that the data can be read from and written to the desired location on the media.

An important and continuing goal in the data storage industry is that of increasing the density of data stored on a medium. For tape storage systems, that goal has led to increasing the track and linear bit density on recording tape, and decreasing the thickness of the magnetic tape medium. However, the development of small footprint, higher performance tape drive systems has created various problems in the design of a tape head assembly for use in such systems.

In a tape drive system, magnetic tape is moved over the surface of the tape head at high speed. Usually the tape head is designed to minimize the spacing between the head and the tape. The spacing between the magnetic head and the magnetic tape is crucial so that the recording gaps of the transducers, which are the source of the magnetic recording flux, are in near contact with the tape to effect writing sharp transitions, and so that the read element is in near contact with the tape to provide effective coupling of the magnetic field from the tape to the read element.

The quantity of data stored on a magnetic tape may be increased by increasing the number of data tracks across the tape. More tracks are made possible by reducing feature sizes of the readers and writers, such as by using thin-film fabrication techniques and magnetoresistive (MR) sensors. However, for various reasons, the feature sizes of readers and writers cannot be arbitrarily reduced, and so factors such as lateral tape motion transients and tape lateral expansion and contraction (e.g., perpendicular to the direction of tape travel) must be balanced with reader/writer sizes that provide acceptable written tracks and readback signals. One issue limiting areal density is misregistration caused by tape lateral expansion and contraction. Tape width can vary by up to about 0.1% due to expansion and contraction caused by changes in humidity, tape tension, temperature, aging etc. This is often referred to as tape dimensional stability (TDS), or more properly, tape dimensional instability (TDI).

If the tape is written in one environment and then read back in another, the TDI may prevent the spacing of the tracks on the tape from precisely matching the spacing of the reading elements during readback. In current products, the change in track spacing due to TDI is small compared to the size of the written tracks and is part of the tracking budget that is considered when designing a product. As the tape capacity increases over time, tracks are becoming smaller and TDI is becoming an increasingly larger portion of the tracking budget and this is a limiting factor for growing areal density.

### BRIEF SUMMARY

An apparatus according to one embodiment includes at least two modules, each of the modules having an array of transducers of a particular type selected from a group consisting of data readers and data writers. Each of the modules also has at least one servo reader. A centerline span of outermost transducers of each of the modules is at least 28% of a usable width of a tape for which the modules are designed. An axis of each array is defined between opposite ends thereof, the axes of the arrays being nominally oriented about parallel to each other. The transducers of each array are spatially arranged along the axis of the associated array such that adjacent pairs of the transducers along the axis have about a uniform separation. The array of a first of the modules is offset from the array of a second of the modules in a first direction parallel to the axis of the array of the second module such that the transducers of the first module are about aligned with the transducers of the second module in an intended direction of tape travel thereacross when the axes are oriented at an angle between greater than 0.2° relative to a line oriented perpendicular to the intended direction of tape travel thereacross. The apparatus also includes a mechanism for orienting the modules to control a transducer pitch presented to a tape.

A product according to one embodiment includes a magnetic recording tape having N servo tracks written thereon in a longitudinal direction. The magnetic recording tape in one approach has M=N or M=N+1 recordable regions thereon. In an alternate approach, the magnetic recording tape has M=N−1 recordable regions thereon when N is an integer less than 5.

An apparatus according to another embodiment includes at least two modules, each of the modules having an array of at least eight transducers selected from a group consisting of data readers and data writers. Each of the modules also has at least one servo reader. A centerline span of outermost transducers of each array is smaller than 10% of a width of a tape for which the modules are designed. The axis of each array is defined between opposite ends thereof, and the axes of the arrays are nominally oriented about parallel to each other. The transducers of each array are spatially arranged along the axis of the associated array such that adjacent pairs of the transducers along the axis have about a uniform separation. The array of a first of the modules is offset from the array of a second of the modules in a first direction parallel to the axis of the array of the second module such that the transducers of the first module are about aligned with the transducers of the second module in an intended direction of tape travel thereacross when the axes are oriented at an angle greater than 0.2° relative to a line oriented perpendicular to the intended direction of tape travel thereacross. The apparatus also includes a mechanism for orienting the modules to control a transducer pitch presented to a tape.

Any of these embodiments may be implemented in a magnetic data storage system such as a tape drive system, which may include a magnetic head, a drive mechanism for passing a magnetic medium (e.g., recording tape) over the magnetic head, and a controller electrically coupled to the magnetic head.

Other aspects and embodiments of the present invention will become apparent from the following detailed description, which, when taken in conjunction with the drawings, illustrate by way of example the principles of the invention.

### BRIEF DESCRIPTION OF THE SEVERAL VIEWS OF THE DRAWINGS

FIG. 1A is a schematic diagram of a simplified tape drive system according to one embodiment.

FIG. 1B is a schematic diagram of a tape cartridge according to one embodiment.

FIG. 2 illustrates a side view of a flat-lapped, bi-directional, two-module magnetic tape head according to one embodiment.

FIG. 2A is a tape bearing surface view taken from Line 2A of FIG. 2.

FIG. 2B is a detailed view taken from Circle 2B of FIG. 2A.

FIG. 2C is a detailed view of a partial tape bearing surface of a pair of modules.

FIG. 3 is a partial tape bearing surface view of a magnetic head having a write-read-write configuration.

FIG. 4 is a partial tape bearing surface view of a magnetic head having a read-write-read configuration.

FIG. 5 is a side view of a magnetic tape head with three modules according to one embodiment where the modules all generally lie along about parallel planes.

FIG. 6 is a side view of a magnetic tape head with three modules in a tangent (angled) configuration.

FIG. 7 is a side view of a magnetic tape head with three modules in an overwrap configuration.

FIGS. 8A-8C are partial top-down views of one module of a magnetic tape head according to one embodiment.

FIGS. 9A-9C are partial top-down views of one module of a magnetic tape head according to one embodiment.

FIG. 10A is a partial top-down view of a system with two modules according to one embodiment.

FIG. 10B is a diagram of the system of FIG. 10A.

FIG. 11A is a partial top-down view of a system with two modules according to one embodiment.

FIG. 11B is a partial top-down view of a system with two modules according to another embodiment.

FIG. 12 is a partial top-down view of a magnetic head with three modules according to one embodiment.

FIG. 13 is a flow chart of a method according to one embodiment.

FIG. 14A is a representational diagram of a tape with shingled tracks written in a non-serpentine fashion according to one embodiment.

FIG. 14B is a representational diagram of a tape with shingled tracks written in a serpentine fashion according to one embodiment.

FIG. 15A is a representational diagram of a magnetic recording tape according to one embodiment.

FIG. 15B is a representational diagram of a magnetic recording tape according to another embodiment.

FIG. 15C is a representational diagram of a magnetic recording tape according to another embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred embodiments of magnetic storage systems, as well as operation and/or component parts thereof.

In one general embodiment, an apparatus includes at least two modules, each of the modules having an array of transducers of a particular type selected from a group consisting of data readers and data writers. Each of the modules also has at least one servo reader. A centerline span of outermost transducers of each of the modules is at least 28% of a usable width of a tape for which the modules are designed. An axis of each array is defined between opposite ends thereof, the axes of the arrays being nominally oriented about parallel to each other. The transducers of each array are spatially arranged along the axis of the associated array such that adjacent pairs of the transducers along the axis have about a uniform separation. The array of a first of the modules is offset from the array of a second of the modules in a first direction parallel to the axis of the array of the second module such that the transducers of the first module are about aligned with the transducers of the second module in an intended direction of tape travel thereacross when the axes are oriented at an angle between greater than 0.2° relative to a line oriented perpendicular to the intended direction of tape travel thereacross. The apparatus also includes a mechanism for orienting the modules to control a transducer pitch presented to a tape.

In one general embodiment, a product includes a magnetic recording tape having N servo tracks written thereon in a longitudinal direction. The magnetic recording tape in one approach has M=N or M=N+1 recordable regions thereon. In an alternate approach, the magnetic recording tape has M=N−1 recordable regions thereon when N is an integer less than 5.

In another general embodiment, an apparatus includes at least two modules, each of the modules having an array of at least eight transducers selected from a group consisting of data readers and data writers. Each of the modules also has at least one servo reader. A centerline span of outermost transducers of each array is smaller than 10% of a width of a tape for which the modules are designed. The axis of each array is defined between opposite ends thereof, and the axes of the arrays are nominally oriented about parallel to each other. The transducers of each array are spatially arranged along the axis of the associated array such that adjacent pairs of the transducers along the axis have about a uniform separation. The array of a first of the modules is offset from the array of a second of the modules in a first direction parallel to the axis of the array of the second module such that the transducers of the first module are about aligned with the transducers of the second module in an intended direction of tape travel thereacross when the axes are oriented at an angle greater than 0.2° relative to a line oriented perpendicular to the intended direction of tape travel thereacross. The apparatus also includes a mechanism for orienting the modules to control a transducer pitch presented to a tape.

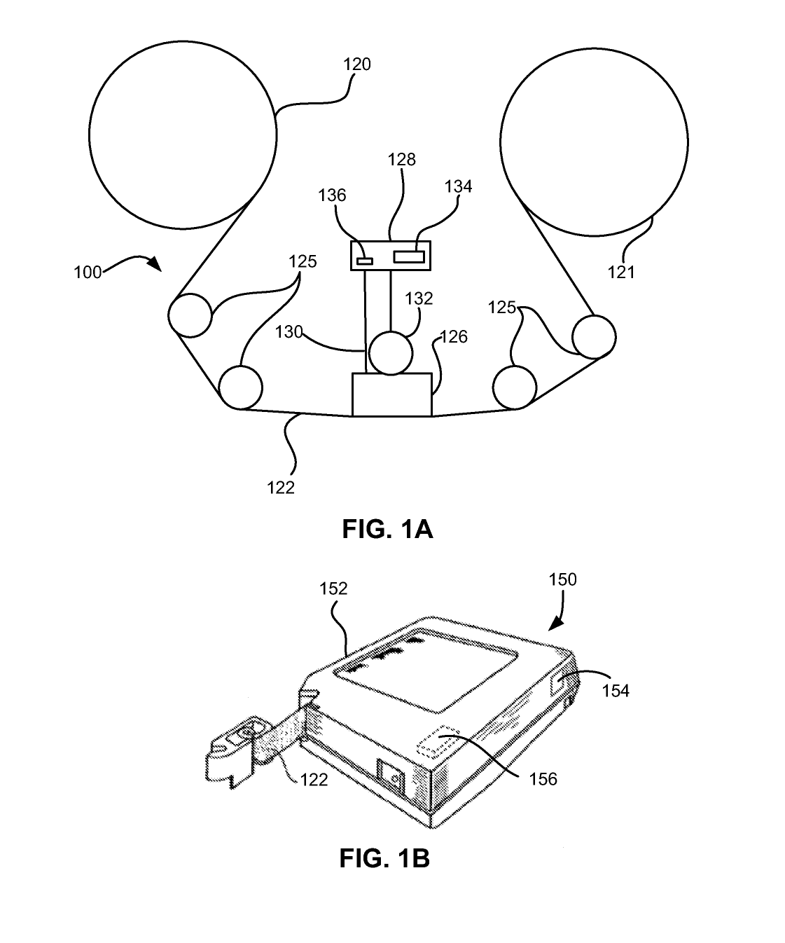

FIG. 1A illustrates a simplified tape drive 100 of a tape-based data storage system, which may be employed in the context of the present invention. While one specific implementation of a tape drive is shown in FIG. 1A, it should be noted that the embodiments described herein may be implemented in the context of any type of tape drive system.

As shown, a tape supply cartridge 120 and a take-up reel 121 are provided to support a tape 122. One or more of the reels may form part of a removable cartridge and are not necessarily part of the system 100. The tape drive, such as that illustrated in FIG. 1A, may further include drive motor(s) to drive the tape supply cartridge 120 and the take-up reel 121 to move the tape 122 over a tape head 126 of any type. Such head may include an array of readers, writers, or both.

Guides 125 guide the tape 122 across the tape head 126. Such tape head 126 is in turn coupled to a controller 128 via a cable 130. The controller 128, may be or include a processor and/or any logic for controlling any subsystem of the drive 100. For example, the controller 128 typically controls head functions such as servo following, data writing, data reading, etc. The controller 128 may operate under logic known in the art, as well as any logic disclosed herein. The controller 128 may be coupled to a memory 136 of any known type, which may store instructions executable by the controller 128. Moreover, the controller 128 may be configured and/or programmable to perform or control some or all of the methodology presented herein. Thus, the controller may be considered configured to perform various operations by way of logic programmed into a chip; software, firmware, or other instructions being available to a processor; etc. and combinations thereof.

The cable 130 may include read/write circuits to transmit data to the head 126 to be recorded on the tape 122 and to receive data read by the head 126 from the tape 122. An actuator 132 controls position of the head 126 relative to the tape 122.

An interface 134 may also be provided for communication between the tape drive 100 and a host (integral or external) to send and receive the data and for controlling the operation of the tape drive 100 and communicating the status of the tape drive 100 to the host, all as will be understood by those of skill in the art.

FIG. 1B illustrates an exemplary tape cartridge 150 according to one embodiment. Such tape cartridge 150 may be used with a system such as that shown in FIG. 1A. As shown, the tape cartridge 150 includes a housing 152, a tape 122 in the housing 152, and a nonvolatile memory 156 coupled to the housing 152. In some approaches, the nonvolatile memory 156 may be embedded inside the housing 152, as shown in FIG. 1B. In more approaches, the nonvolatile memory 156 may be attached to the inside or outside of the housing 152 without modification of the housing 152. For example, the nonvolatile memory may be embedded in a self-adhesive label 154. In one preferred embodiment, the nonvolatile memory 156 may be a Flash memory device, ROM device, etc., embedded into or coupled to the inside or outside of the tape cartridge 150. The nonvolatile memory is accessible by the tape drive and the tape operating software (the driver software), and/or other device.

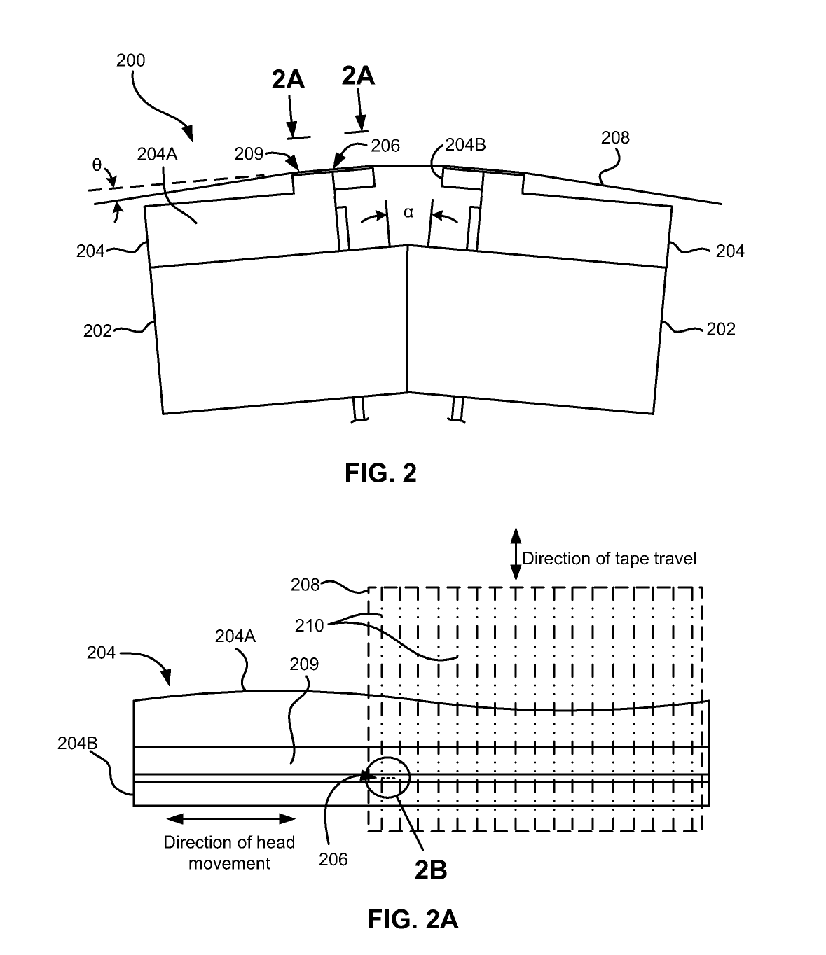

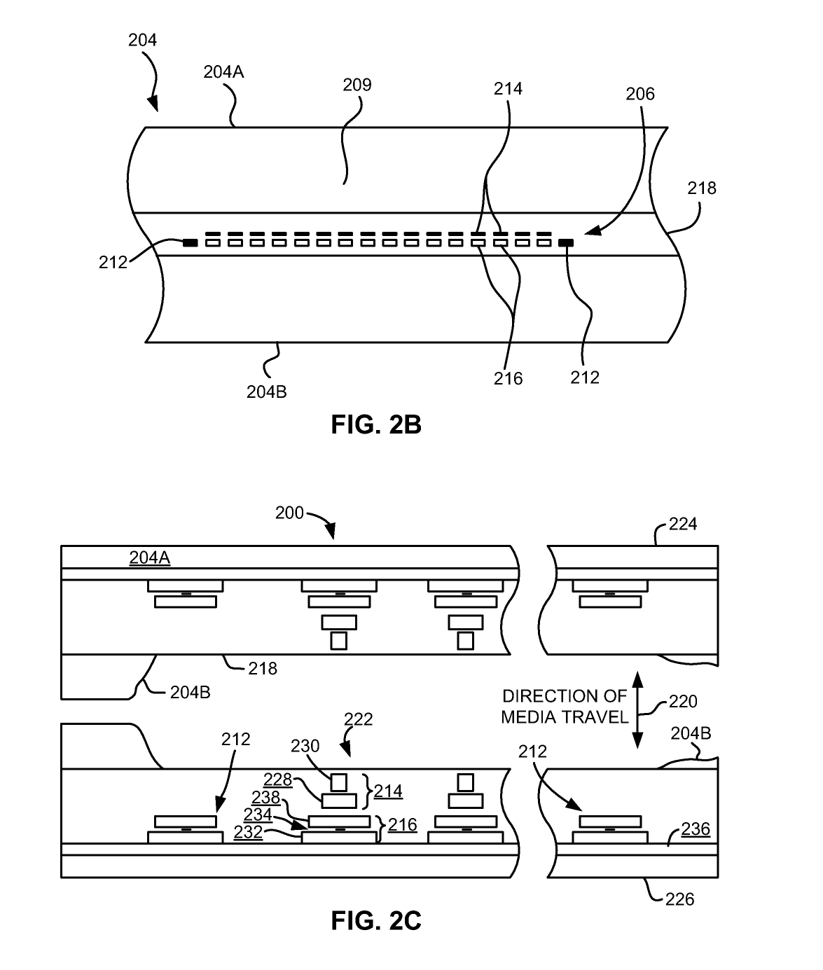

By way of example, FIG. 2 illustrates a side view of a flat-lapped, bi-directional, two-module magnetic tape head 200 which may be implemented in the context of the present invention. As shown, the head includes a pair of bases 202, each equipped with a module 204, and fixed at a small angle α with respect to each other. The bases may be “U-beams” that are adhesively coupled together. Each module 204 includes a substrate 204A and a closure 204B with a thin film portion, commonly referred to as a “gap” in which the readers and/or writers 206 are formed. In use, a tape 208 is moved over the modules 204 along a media (tape) bearing surface 209 in the manner shown for reading and writing data on the tape 208 using the readers and writers. The wrap angle θ of the tape 208 at edges going onto and exiting the flat media support surfaces 209 are usually between about 0.1 degree and about 5 degrees.

The substrates 204A are typically constructed of a wear resistant material, such as a ceramic. The closures 204B made of the same or similar ceramic as the substrates 204A.

The readers and writers may be arranged in a piggyback or merged configuration. An illustrative piggybacked configuration comprises a (magnetically inductive) writer transducer on top of (or below) a (magnetically shielded) reader transducer (e.g., a magnetoresistive reader, etc.), wherein the poles of the writer and the shields of the reader are generally separated. An illustrative merged configuration comprises one reader shield in the same physical layer as one writer pole (hence, “merged”). The readers and writers may also be arranged in an interleaved configuration. Alternatively, each array of channels may be readers or writers only. Any of these arrays may contain one or more servo track readers for reading servo data on the medium.

FIG. 2A illustrates the tape bearing surface 209 of one of the modules 204 taken from Line 2A of FIG. 2. A representative tape 208 is shown in dashed lines. The module 204 is preferably long enough to be able to support the tape as the head steps between data bands.

In this example, the tape 208 includes 4 to 22 data bands, e.g., with 8 data bands and 9 servo tracks 210, as shown in FIG. 2A on a one-half inch wide tape 208. The data bands are defined between servo tracks 210. Each data band may include a number of data tracks, for example 1024 data tracks (not shown). During read/write operations, the readers and/or writers 206 are positioned to specific track positions within one of the data bands. Outer readers, sometimes called servo readers, read the servo tracks 210. The servo signals are in turn used to keep the readers and/or writers 206 aligned with a particular set of tracks during the read/write operations.

FIG. 2B depicts a plurality of readers and/or writers 206 formed in a gap 218 on the module 204 in Circle 2B of FIG. 2A. As shown, the array of readers and writers 206 includes, for example, 16 writers 214, 16 readers 216 and two servo readers 212, though the number of elements may vary. Illustrative embodiments include 8, 16, 32, 40, and 64 active readers and/or writers 206 per array, and alternatively interleaved designs having odd numbers of reader or writers such as 17, 25, 33, etc. An illustrative embodiment includes 32 readers per array and/or 32 writers per array, where the actual number of transducer elements could be greater, e.g., 33, 34, etc. This allows the tape to travel more slowly, thereby reducing speed-induced tracking and mechanical difficulties and/or execute fewer “wraps” to fill or read the tape. While the readers and writers may be arranged in a piggyback configuration as shown in FIG. 2B, the readers 216 and writers 214 may also be arranged in an interleaved configuration. Alternatively, each array of readers and/or writers 206 may be readers or writers only, and the arrays may contain one or more servo readers 212. As noted by considering FIGS. 2 and 2A-B together, each module 204 may include a complementary set of readers and/or writers 206 for such things as bi-directional reading and writing, read-while-write capability, backward compatibility, etc.

FIG. 2C shows a partial tape bearing surface view of complimentary modules of a magnetic tape head 200 according to one embodiment. In this embodiment, each module has a plurality of read/write (R/W) pairs in a piggyback configuration formed on a common substrate 204A and an optional electrically insulative layer 236. The writers, exemplified by the write head 214 and the readers, exemplified by the read head 216, are aligned parallel to a direction of travel of a tape medium thereacross to form an R/W pair, exemplified by the R/W pair 222.

Several R/W pairs 222 may be present, such as 8, 16, 32 pairs, etc. The R/W pairs 222 as shown are linearly aligned in a direction generally perpendicular to a direction of tape travel thereacross. However, the pairs may also be aligned diagonally, etc. Servo readers 212 are positioned on the outside of the array of R/W pairs, the function of which is well known.

Generally, the magnetic tape medium moves in either a forward or reverse direction as indicated by arrow 220. The magnetic tape medium and head assembly 200 operate in a transducing relationship in the manner well-known in the art. The piggybacked MR head assembly 200 includes two thin-film modules 224 and 226 of generally identical construction.

Modules 224 and 226 are joined together with a space present between closures 204B thereof (partially shown) to form a single physical unit to provide read-while-write capability by activating the writer of the leading module and reader of the trailing module aligned with the writer of the leading module parallel to the direction of tape travel relative thereto. When a module 224, 226 of a piggyback head 200 is constructed, layers are formed in the gap 218 created above an electrically conductive substrate 204A (partially shown), e.g., of AlTiC, in generally the following order for the R/W pairs 222: an insulating layer 236, a first shield 232 typically of an iron alloy such as NiFe (-), CZT or Al—Fe—Si (Sendust), a sensor 234 for sensing a data track on a magnetic medium, a second shield 238 typically of a nickel-iron alloy (e.g., ˜80/20 at % NiFe, also known as permalloy), first and second writer pole tips 228, 230, and a coil (not shown). The sensor may be of any known type, including those based on MR, GMR, AMR, tunneling magnetoresistance (TMR), etc.

The first and second writer poles 228, 230 may be fabricated from high magnetic moment materials such as ˜45/55 NiFe. Note that these materials are provided by way of example only, and other materials may be used. Additional layers such as insulation between the shields and/or pole tips and an insulation layer surrounding the sensor may be present. Illustrative materials for the insulation include alumina and other oxides, insulative polymers, etc.

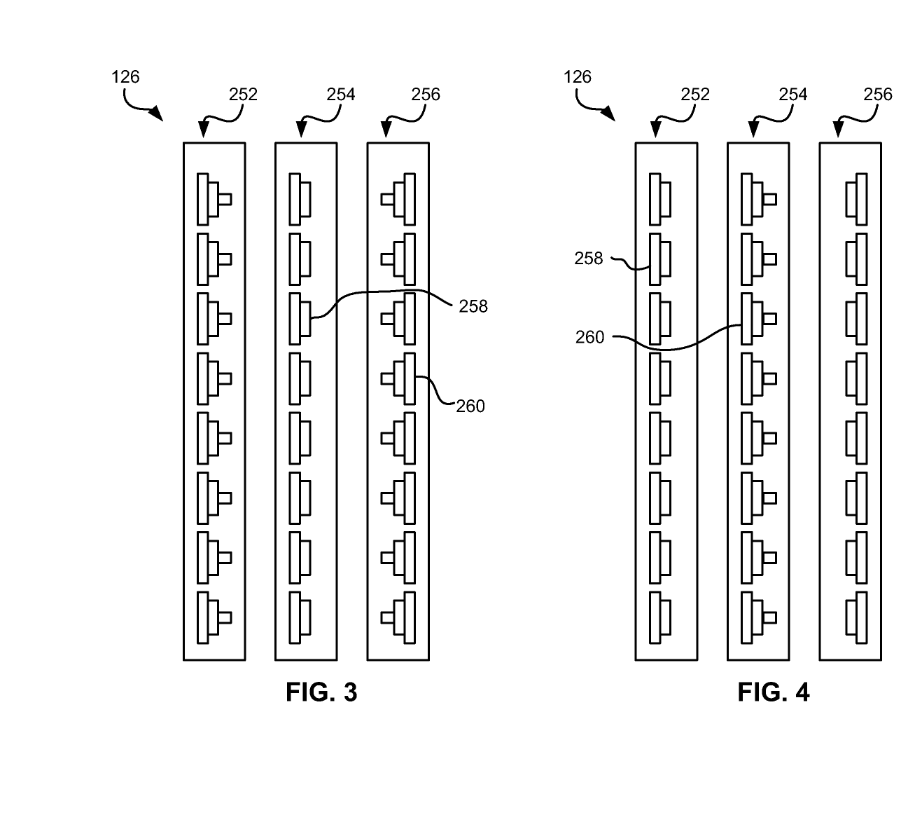

The configuration of the tape head 126 according to one embodiment includes multiple modules, preferably three or more. In a write-read-write (W-R-W) head, outer modules for writing flank one or more inner modules for reading. Referring to FIG. 3, depicting a W-R-W configuration, the outer modules 252, 256 each include one or more arrays of writers 260. The inner module 254 of FIG. 3 includes one or more arrays of readers 258 in a similar configuration. Variations of a multi-module head include a R-W-R head (FIG. 4), a R-R-W head, a W-W-R head, etc. In yet other variations, one or more of the modules may have read/write pairs of transducers. Moreover, more than three modules may be present. In further approaches, two outer modules may flank two or more inner modules, e.g., in a W-R-R-W, a R-W-W-R arrangement, etc. For simplicity, a W-R-W head is used primarily herein to exemplify embodiments of the present invention. One skilled in the art apprised with the teachings herein will appreciate how permutations of the present invention would apply to configurations other than a W-R-W configuration.

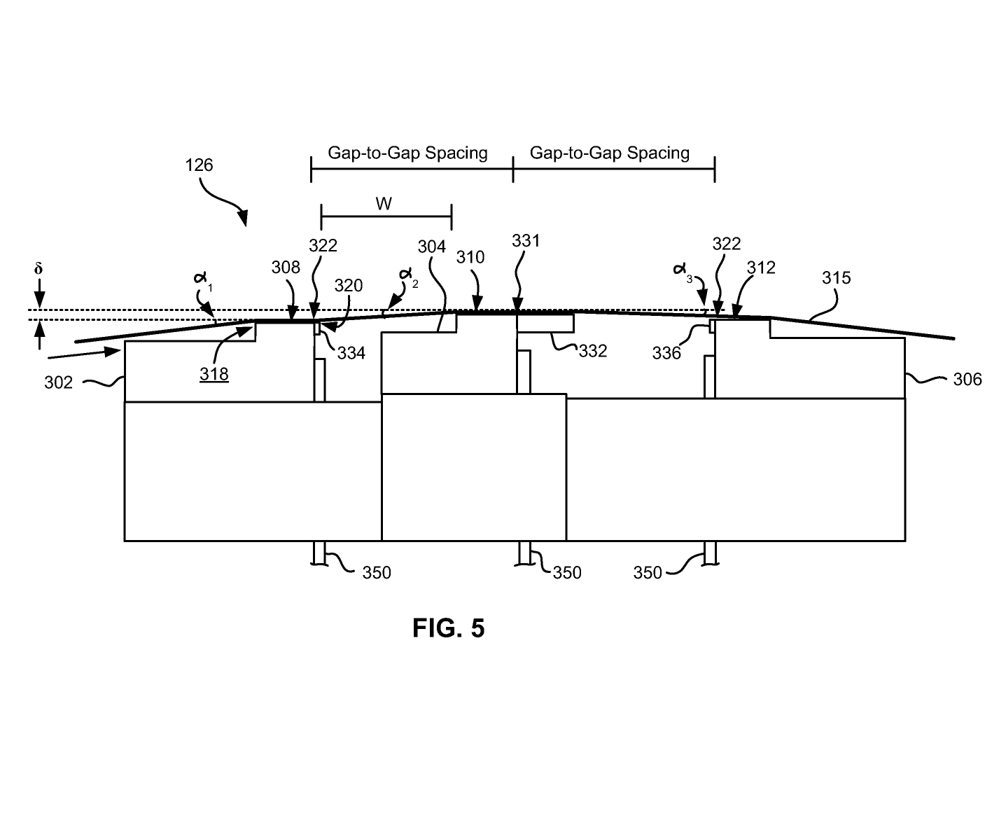

FIG. 5 illustrates a magnetic head 126 according to one embodiment of the present invention that includes first, second and third modules 302, 304, 306 each having a tape bearing surface 308, 310, 312 respectively, which may be flat, contoured, etc. Note that while the term “tape bearing surface” appears to imply that the surface facing the tape 315 is in physical contact with the tape bearing surface, this is not necessarily the case. Rather, only a portion of the tape may be in contact with the tape bearing surface, constantly or intermittently, with other portions of the tape riding (or “flying”) above the tape bearing surface on a layer of air, sometimes referred to as an “air bearing”. The first module 302 will be referred to as the “leading” module as it is the first module encountered by the tape in a three module design for tape moving in the indicated direction. The third module 306 will be referred to as the “trailing” module. The trailing module follows the middle module and is the last module seen by the tape in a three module design. The leading and trailing modules 302, 306 are referred to collectively as outer modules. Also note that the outer modules 302, 306 will alternate as leading modules, depending on the direction of travel of the tape 315.

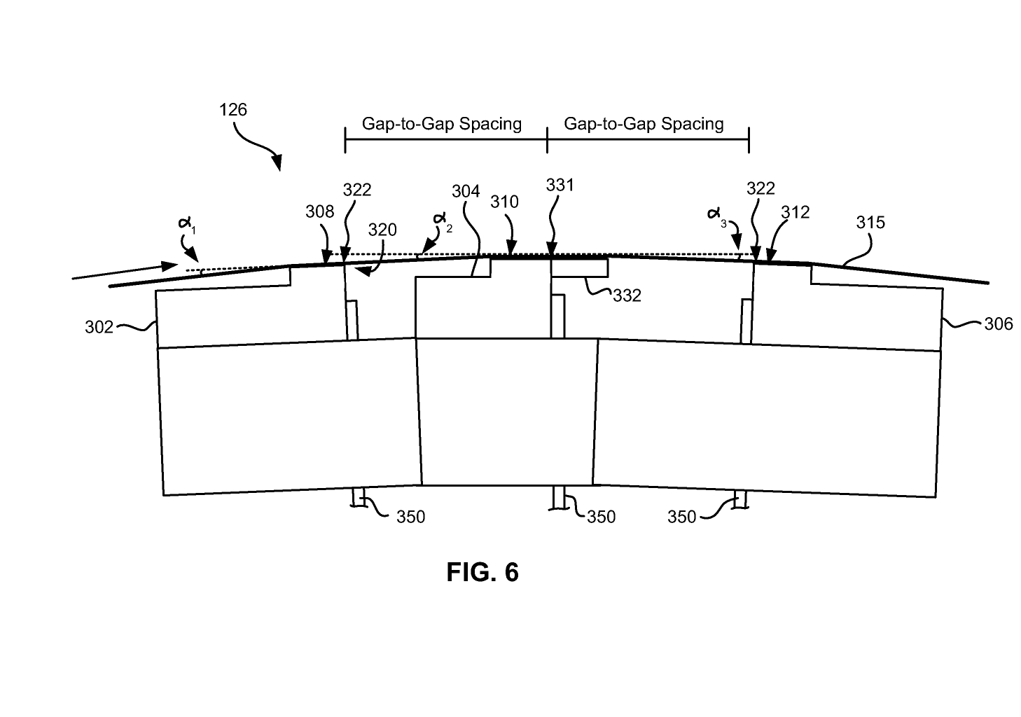

In one embodiment, the tape bearing surfaces 308, 310, 312 of the first, second and third modules 302, 304, 306 lie on about parallel planes (which is meant to include parallel and nearly parallel planes, e.g., between parallel and tangential as in FIG. 6), and the tape bearing surface 310 of the second module 304 is above the tape bearing surfaces 308, 312 of the first and third modules 302, 306. As described below, this has the effect of creating the desired wrap angle α₂ of the tape relative to the tape bearing surface 310 of the second module 304.

Where the tape bearing surfaces 308, 310, 312 lie along parallel or nearly parallel yet offset planes, intuitively, the tape should peel off of the tape bearing surface 308 of the leading module 302. However, the vacuum created by the skiving edge 318 of the leading module 302 has been found by experimentation to be sufficient to keep the tape adhered to the tape bearing surface 308 of the leading module 302. The trailing edge 320 of the leading module 302 (the end from which the tape leaves the leading module 302) is the approximate reference point which defines the wrap angle α_{z} over the tape bearing surface 310 of the second module 304. The tape stays in close proximity to the tape bearing surface until close to the trailing edge 320 of the leading module 302. Accordingly, read and/or write elements 322 may be located near the trailing edges of the outer modules 302, 306. These embodiments are particularly adapted for write-read-write applications.

A benefit of this and other embodiments described herein is that, because the outer modules 302, 306 are fixed at a determined offset from the second module 304, the inner wrap angle α₂ is fixed when the modules 302, 304, 306 are coupled together or are otherwise fixed into a head. The inner wrap angle α₂ is approximately tan⁻¹(δ/W) where δ is the height difference between the planes of the tape bearing surfaces 308, 310 and W is the width between the opposing ends of the tape bearing surfaces 308, 310. An illustrative inner wrap angle α₂ is in a range of about 0.5° to about 1.1°, though can be any angle required by the design.

Beneficially, the inner wrap angle α₂ may be set slightly less on the side of the module 304 receiving the tape (leading edge) than the inner wrap angle α₃ on the trailing edge, as the tape 315 rides above the trailing module 306. This difference is generally beneficial as a smaller α₃ tends to oppose what has heretofore been a steeper exiting effective wrap angle.

Note that the tape bearing surfaces 308, 312 of the outer modules 302, 306 are positioned to achieve a negative wrap angle at the trailing edge 320 of the leading module 302. This is generally beneficial in helping to reduce friction due to contact with the trailing edge 320, provided that proper consideration is given to the location of the crowbar region that forms in the tape where it peels off the head. This negative wrap angle also reduces flutter and scrubbing damage to the elements on the leading module 302. Further, at the trailing module 306, the tape 315 flies over the tape bearing surface 312 so there is virtually no wear on the elements when tape is moving in this direction. Particularly, the tape 315 entrains air and so will not significantly ride on the tape bearing surface 312 of the third module 306 (some contact may occur). This is permissible, because the leading module 302 is writing while the trailing module 306 is idle.

Writing and reading functions are performed by different modules at any given time. In one embodiment, the second module 304 includes a plurality of data and optional servo readers 331 and no writers. The first and third modules 302, 306 include a plurality of writers 322 and no readers, with the exception that the outer modules 302, 306 may include optional servo readers. The servo readers may be used to position the head during reading and/or writing operations. The servo reader(s) on each module are typically located towards the end of the array of readers or writers.

By having only readers or side by side writers and servo readers in the gap between the substrate and closure, the gap length can be substantially reduced. Typical heads have piggybacked readers and writers, where the writer is formed above each reader. A typical gap is 25-35 microns. However, irregularities on the tape may tend to droop into the gap and create gap erosion. Thus, the smaller the gap is the better. The smaller gap enabled herein exhibits fewer wear related problems.

In some embodiments, the second module 304 has a closure, while the first and third modules 302, 306 do not have a closure. Where there is no closure, preferably a hard coating is added to the module. One preferred coating is diamond-like carbon (DLC).

In the embodiment shown in FIG. 5, the first, second, and third modules 302, 304, 306 each have a closure 332, 334, 336, which extends the tape bearing surface of the associated module, thereby effectively positioning the read/write elements away from the edge of the tape bearing surface. The closure 332 on the second module 304 can be a ceramic closure of a type typically found on tape heads. The closures 334, 336 of the first and third modules 302, 306, however, may be shorter than the closure 332 of the second module 304 as measured parallel to a direction of tape travel over the respective module. This enables positioning the modules closer together. One way to produce shorter closures 334, 336 is to lap the standard ceramic closures of the second module 304 an additional amount. Another way is to plate or deposit thin film closures above the elements during thin film processing. For example, a thin film closure of a hard material such as Sendust or nickel-iron alloy (e.g., 45/55) can be formed on the module.

With reduced-thickness ceramic or thin film closures 334, 336 or no closures on the outer modules 302, 306, the write-to-read gap spacing can be reduced to less than about 1 mm, e.g., about 0.75 mm, or 50% less than standard Linear Tape Open (LTO) tape head spacing. The open space between the modules 302, 304, 306 can still be set to approximately 0.5 to 0.6 mm, which in some embodiments is ideal for stabilizing tape motion over the second module 304.

Depending on tape tension and stiffness, it may be desirable to angle the tape bearing surfaces of the outer modules relative to the tape bearing surface of the second module. FIG. 6 illustrates an embodiment where the modules 302, 304, 306 are in a tangent or nearly tangent (angled) configuration. Particularly, the tape bearing surfaces of the outer modules 302, 306 are about parallel to the tape at the desired wrap angle α₂ of the second module 304. In other words, the planes of the tape bearing surfaces 308, 312 of the outer modules 302, 306 are oriented at about the desired wrap angle α₂ of the tape 315 relative to the second module 304. The tape will also pop off of the trailing module 306 in this embodiment, thereby reducing wear on the elements in the trailing module 306. These embodiments are particularly useful for write-read-write applications. Additional aspects of these embodiments are similar to those given above.

Typically, the tape wrap angles may be set about midway between the embodiments shown in FIGS. 5 and 6.

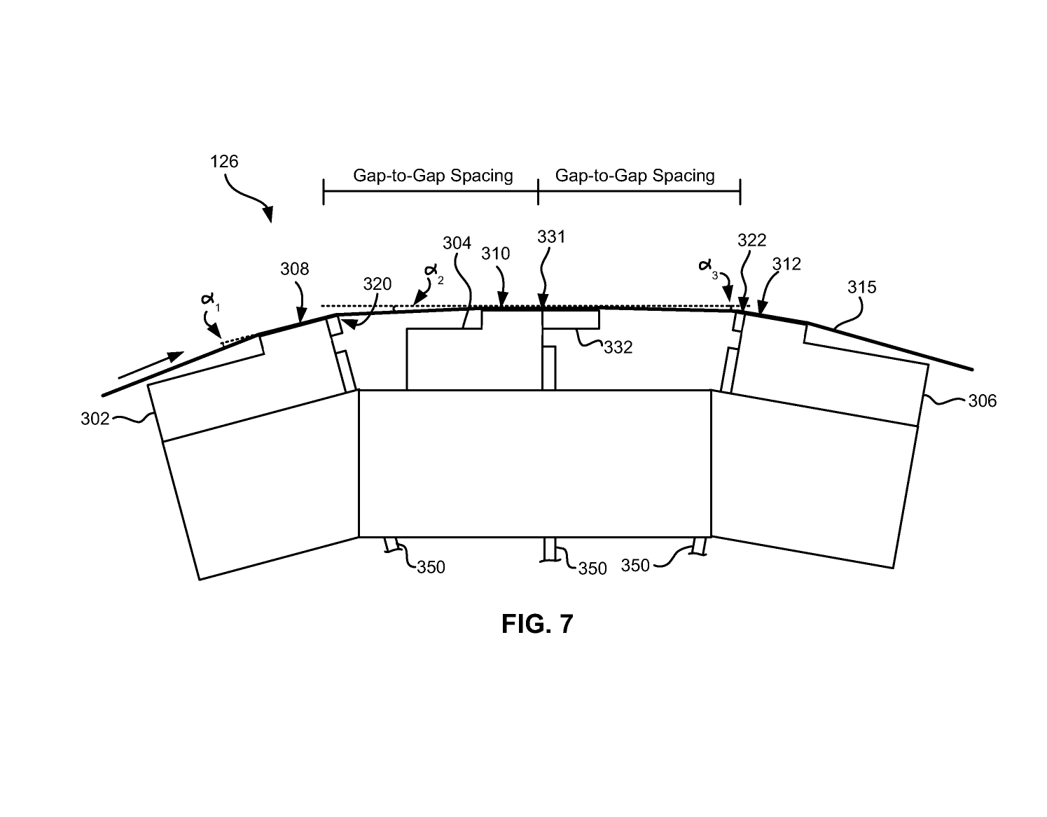

FIG. 7 illustrates an embodiment where the modules 302, 304, 306 are in an overwrap configuration. Particularly, the tape bearing surfaces 308, 312 of the outer modules 302, 306 are angled slightly more than the tape 315 when set at the desired wrap angle α₂ relative to the second module 304. In this embodiment, the tape does not pop off of the trailing module, allowing it to be used for writing or reading. Accordingly, the leading and middle modules can both perform reading and/or writing functions while the trailing module can read any just-written data. Thus, these embodiments are preferred for write-read-write, read-write-read, and write-write-read applications. In the latter embodiments, closures should be wider than the tape canopies for ensuring read capability. The wider closures will force a wider gap-to-gap separation. Therefore a preferred embodiment has a write-read-write configuration, which may use shortened closures that thus allow closer gap-to-gap separation.

Additional aspects of the embodiments shown in FIGS. 6 and 7 are similar to those given above.

A 32 channel version of a multi-module head 126 may use cables 350 having leads on the same pitch as current 16 channel piggyback LTO modules, or alternatively the connections on the module may be organ-keyboarded for a 50% reduction in cable span. Over-under, writing pair unshielded cables can be used for the writers, which may have integrated servo readers.

The outer wrap angles α₁ may be set in the drive, such as by guides of any type known in the art, such as adjustable rollers, slides, etc. For example, rollers having an offset axis may be used to set the wrap angles. The offset axis creates an orbital arc of rotation, allowing precise alignment of the wrap angle α₁.

To assemble any of the embodiments described above, conventional u-beam assembly can be used. Accordingly, the mass of the resultant head can be maintained or even reduced relative to heads of previous generations. In other approaches, the modules may be constructed as a unitary body. Those skilled in the art, armed with the present teachings, will appreciate that other known methods of manufacturing such heads may be adapted for use in constructing such heads.

As noted above, tape lateral expansion and contraction present many challenges to increasing data track density on conventional products. Conventional products have attempted to compensate for tape lateral expansion and contraction by controlling tape width by tension and improving the characteristics of the media itself. However, these methods fail to fully cancel the tape lateral expansion and contraction, and actually lead to other problems, including tape stretch and media cost increases, respectively.

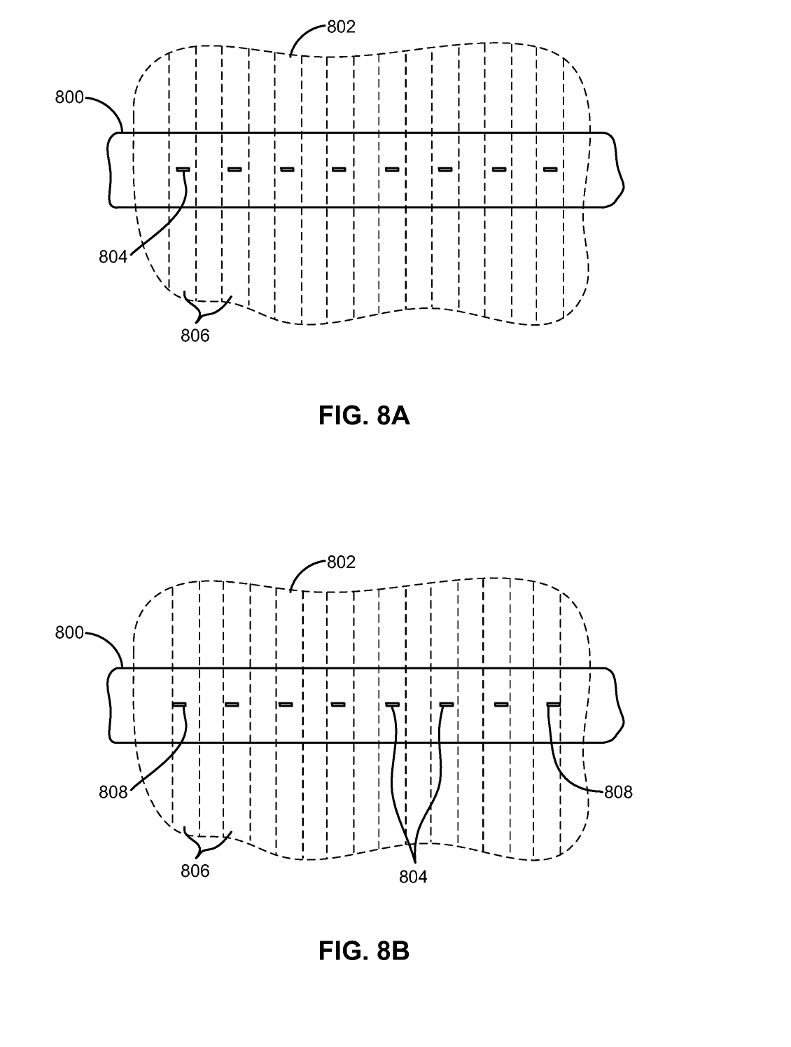

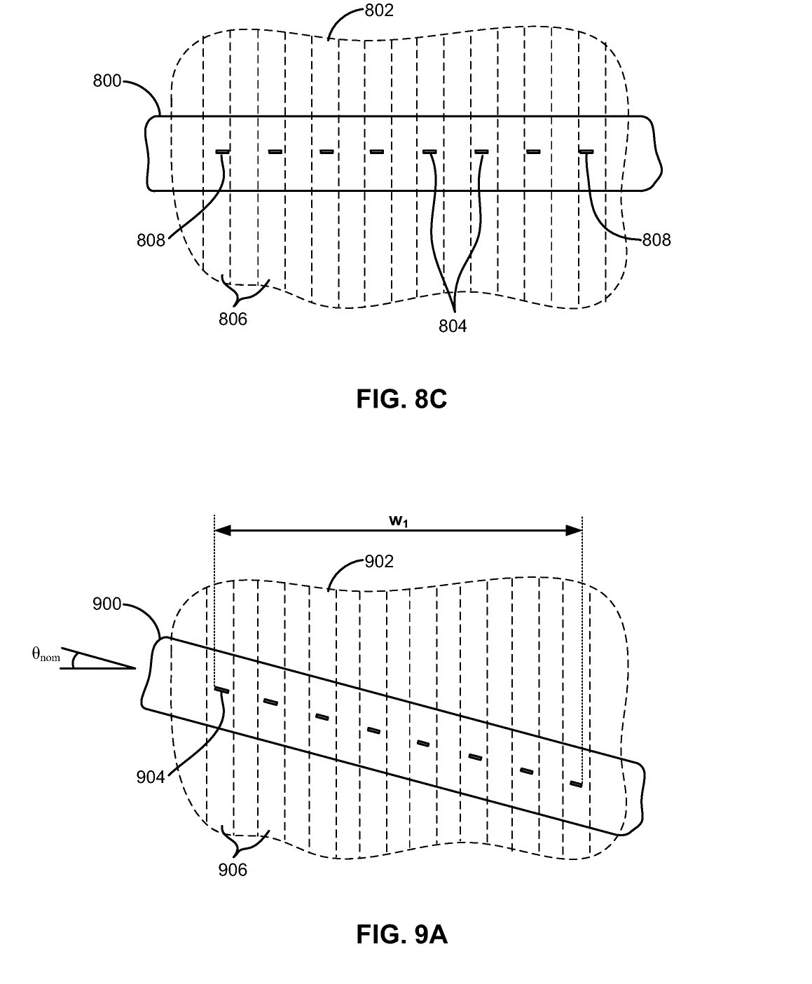

FIGS. 8A-8C are intended to depict the effect of tape lateral expansion and contraction on transducer arrays position relative thereto, and are in no way intended to limit the invention. FIG. 8A depicts a module 800 relative to the tape 802, where the tape has a nominal width. As shown, the transducers 804 are favorably aligned with the data tracks 806 on the tape 802. However, FIG. 8B illustrates the effect of tape lateral contraction. As shown, contraction of the tape causes the data tracks to contract as well, and the outermost transducers 808 are positioned along the outer edges of the outer data tracks as a result. Moreover, FIG. 8C depicts the effect of tape lateral expansion. Here expansion of the tape causes the data tracks to move farther apart, and the outermost transducers 808 are positioned along the inner edges of the outer data tracks as a result. If the tape lateral contraction is greater than that shown in FIG. 8B, or the tape lateral expansion is greater than that shown in FIG. 8C, the outermost transducers 808 will cross onto adjacent tracks, thereby causing the adjacent tracks to be overwritten during a writing operation and/or resulting in readback of the wrong track during a readback operation. Moreover, running effects, such as tape skew and lateral shifting may exacerbate such problems, particularly for tape having shingled data tracks.

Thus, it would be desirable to develop a tape drive system able to read and/or write tracks onto the tape in the proper position, regardless of the extent of tape lateral expansion and/or contraction at any given time. Various embodiments described and/or suggested herein overcome the foregoing challenges of conventional products, by orienting at least two modules of a tape drive system e.g., by pivoting, rotating and/or tilting, thereby selectively altering the pitch of the transducers in their arrays, as will soon become apparent.

By selectively orienting a module, the pitch of the transducers on the module is thereby altered, preferably aligning the transducers with the tracks on a tape for a given tape lateral expansion and/or contraction. Tape contraction (shrinkage) can be dealt with by orienting a nominally non-offset head, but tape expansion (dilation) cannot. Thus, to accommodate both shrinkage and dilation about a “nominal: the head must be statically oriented at a nominal angle of at least approximately 0.2° as will be explained below. Thereafter, smaller angular adjustments (e.g., about 1° or lower, but could be more) may be made to the already oriented module in order to compensate for any variation of the tape lateral expansion and/or contraction, thereby keeping the transducers aligned with tracks on the tape.

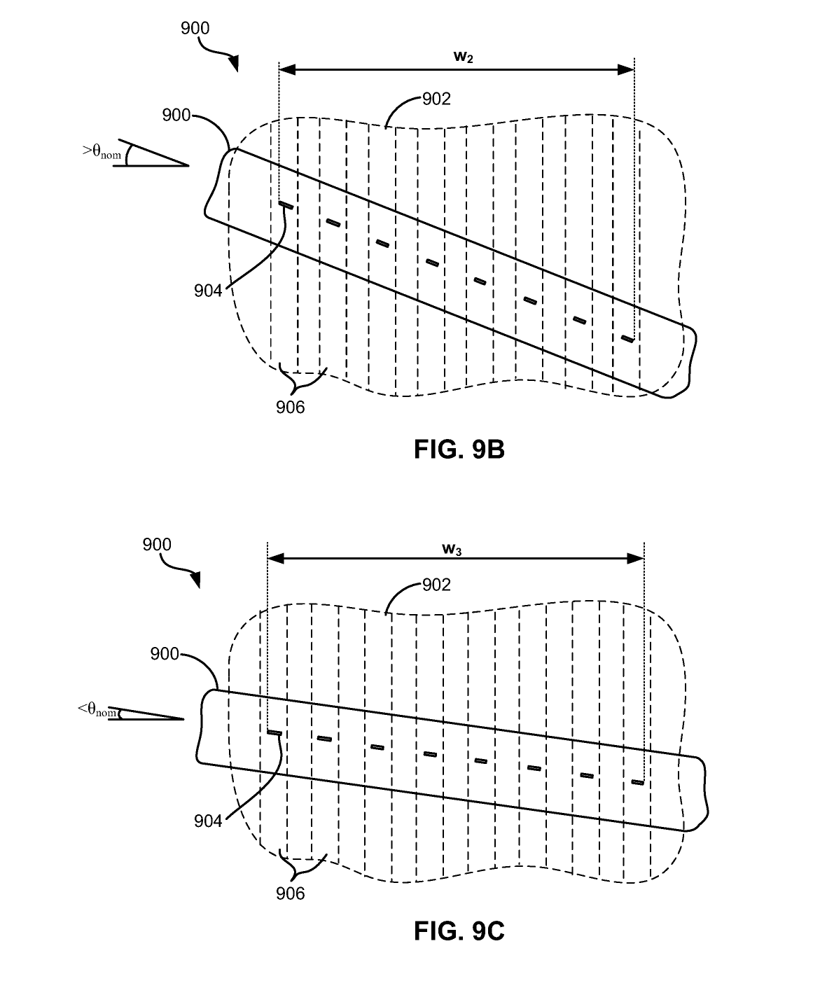

FIGS. 9A-9C illustrate representational views of the effects of orienting a module having transducer arrays. It should be noted that the angles of orientation illustrated in FIGS. 9A-9C are an exaggeration (e.g., larger than would typically be observed), and are in no way intended to limit the invention.

Referring to FIG. 9A, the module 900 is shown relative to the tape 902, where the tape has a nominal width. As illustrated, the module 900 is oriented at an angle θₙₒₘ such that the transducers 904 are favorably aligned with the data tracks 906 on the tape 902. However, when the tape 902 experiences tape lateral contraction and/or expansion, the data tracks 906 on the tape contract and/or expand as well. As a result, the transducers on the module are no longer favorably aligned with the data tracks 906 on the tape 902.

In FIG. 9B, the tape 902 has experienced tape lateral contraction. Therefore, in a manner exemplified by FIG. 8B, the transducers 904 on the module 900 of FIG. 9B would no longer be favorably aligned with the data tracks 906 on the tape 902 if no adjustment were made. However, as alluded to above, smaller angular adjustments may be made to the already-oriented module 900 in order to compensate for tape lateral contraction. Therefore, referring again to FIG. 9B, the angle of orientation >θₙₒₘ of the module 900 is further oriented to an angle greater than θₙₒₘ. By increasing the angle of orientation >θₙₒₘ the effective width w₂ of the array of transducers decreases from the effective width w₁ illustrated in FIG. 9A. This also translates to a reduction in the effective pitch between the transducers, thereby realigning the transducers along the contracted data tracks 906 on the tape 902 as shown in FIG. 9B.

On the other hand, when the tape experiences tape lateral expansion, the data tracks on the tape expand as well. As a result, the transducers on the module would no longer be favorably aligned with the data tracks on the tape if no adjustments were made. With reference to FIG. 9C, the tape 902 has experienced tape lateral expansion. As a result, further angular adjustments may be made to the angle of orientation of the module in order to compensate for the tape lateral expansion. Therefore, referring again to FIG. 9C, the angle of orientation <θₙₒₘ of the module 900 is reduced to an angle less than θₙₒₘ. By decreasing the angle of orientation <θₙₒₘ the effective width w₃ of the array of transducers 904 increases from the effective width w₁ illustrated in FIG. 9A. Moreover, reducing the effective width of the array of transducers 904 also causes the effective pitch between the transducers to be reduced, thereby realigning the transducers along the data tracks 906 on the tape 902.

In a preferred approach, magnetic tape systems have two or more modules, each having an array of transducers, typically in a row. Depending on the desired embodiment, the additional rows of transducers may allow the system to read verify during the write process, but is not limited thereto. As mentioned above, the foregoing conventional challenges may be overcome by tilting a given module, thereby selectively altering the pitch of the transducers in the array.

By providing a system that compensates for tape lateral expansion and/or contraction, various embodiments enable use of wider readers, resulting in a better signal to noise ratio (SNR), and/or smaller data tracks, resulting in a higher capacity per unit area of the media.

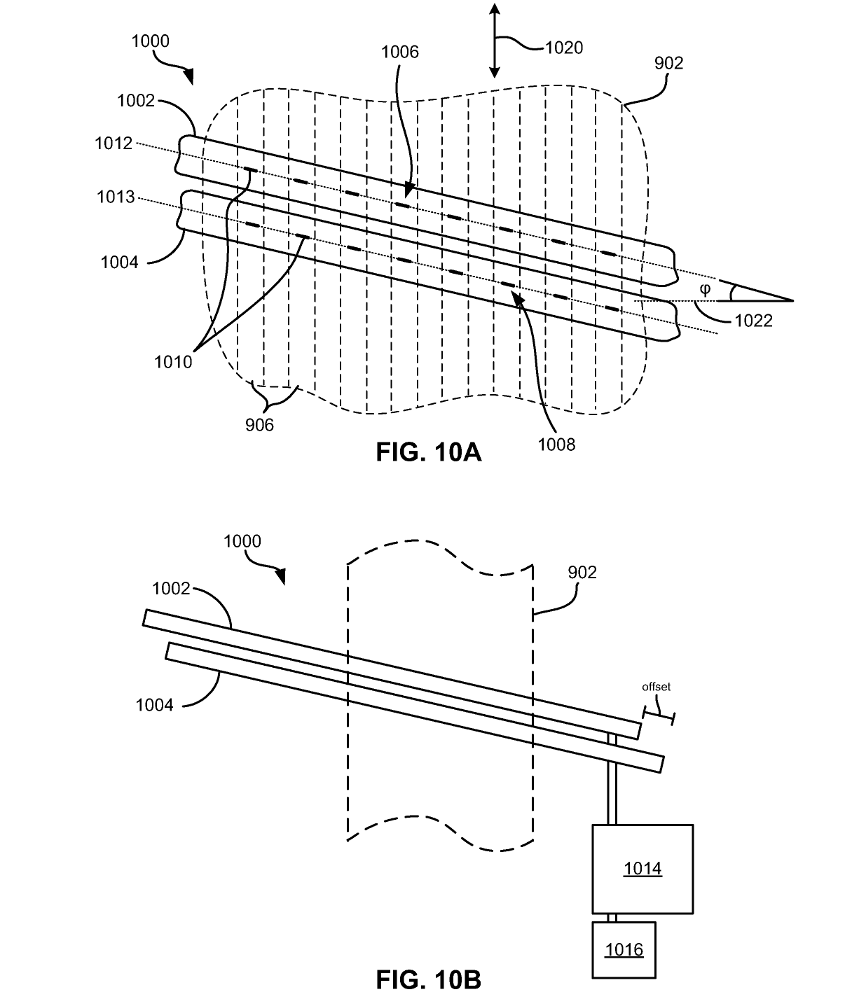

FIGS. 10A-10B depict a system 1000 for compensating for tape lateral expansion and/or contraction, in accordance with one embodiment. As an option, the present system 1000 may be implemented in conjunction with features from any other embodiment listed herein, such as those described with reference to the other FIGS. Of course, however, system 1000 and others presented herein may be used in various applications and/or in permutations which may or may not be specifically described in the illustrative embodiments listed herein. Further, the system 1000 presented herein may be used in any desired environment.

Referring to FIGS. 10A-10B, the system 1000 includes modules 1002, 1004, each of which have an array 1006, 1008 of transducers 1010. The modules 1002, 1004, are preferably fixed relative to each other. In view of the present description, “fixed” is intended to mean constrained from a directional movement relative to each other such that the arrays of each maintain a fixed position relative to each other. According to various approaches, the modules may be fixed relative to each other by using rods, fasteners, adhesives, cables, wire, etc. Moreover, according to different embodiments, the modules are preferably fixed relative to each other prior to being installed in the system 1000, head, etc. depending on the desired embodiment. However, the modules are preferably selectively orientable (e.g., rotatable) as a single structure about a pivot point while remaining fixed relative to each other, as will soon become apparent.

With continued reference to FIGS. 10A-10B, the modules 1002, 1004, are preferably fixed such that the axes 1012, 1013 of the arrays 1006, 1008 are oriented about parallel to each other, respectively. As illustrated in FIGS. 10A-10B, the axes 1012, 1013 of each array of transducers are defined by the dashed lines that lie between opposite ends thereof, e.g., positioned farthest apart.

Referring now to FIG. 10A, the array 1006 of a first module 1002 is offset from the array 1008 of a second module 1004 in a first direction parallel to the axis 1013 of the array 1008 of the second module 1004. The modules 1002, 1004 are also set to a nominal angle in the drive so that the transducers of the arrays are aligned along the data tracks 906 on a tape 902 having nominal tape lateral expansion.

With continued reference to FIG. 10A, the arrays 1006, 1008 of the transducers 1010 of the first and second modules are preferably offset such that the transducers 1010 of the first module 1002 are about aligned with the transducers 1010 of the second module 1004 in an intended direction 1020 of tape travel thereacross when the axes are oriented at an angle φ between greater than about 0.05°, more preferably greater than about 0.2°, in some approaches between 0.2° and about 10°, and ideally between about 0.25° and about 6°, relative to a line 1022 oriented perpendicular to the intended direction 1020 of tape travel.

In addition, the inventors have surprisingly and unexpectedly found that the various embodiments described below, and having the angle γ in the range between greater than about 0.2° and about 10°, enable writing and reading that does not steer the tape or cause media damage over the life of the tape. For example, the inventors expected the skiving edges of the modules to steer the tape laterally.

Angles of orientation greater than within the specified range (e.g., greater than about 10°) are undesirable as the higher angles cause steering of the tape when used. However, as described above, the angles of orientation within the specified range unexpectedly and unforeseeably did not result in steering of the tape. Moreover, it is more difficult to distinguish between tape lateral expansion and/or contraction and skew when angles of orientation of the modules are greater than within the specified range. This may cause difficulties when matching the dimensional conditions of the tape and/or titling state of the modules of the current operation to that of the previous operation (explained in further detail below). It should also be noted that the angle of orientation φ illustrated in FIG. 10A is exaggerated (e.g., larger than within the desired range), and is in no way intended to limit the invention.

Depending on the desired embodiment, the modules themselves may be offset to effect the shifting of the transducer arrays, e.g., as shown by the offset (offset) in FIG. 10B. Alternatively, the transducer arrays may be positioned on the respective module in a specified position to effect the offset while the modules themselves are not offset in the drive; or combinations thereof.

With continued reference to FIG. 10B, the system 1000 includes a mechanism 1014, such as a tape dimensional instability compensation mechanism, for orienting the modules to control a transducer pitch presented to a tape. The tape dimensional instability compensation mechanism 1014 preferably allows for the orientation of the modules to be done while the modules are reading and/or writing. The tape dimensional instability compensation mechanism 1014 may be any known mechanism suitable for orienting the modules. Illustrative tape dimensional instability compensation mechanisms 1014 include worm screws, voice coil actuators, thermal actuators, piezoelectric actuators, etc.

A controller 1016 in one approach is configured to control the tape dimensional instability compensation mechanism 1014 based on a readback signal of the tape, e.g., servo signals, data signals, a combination of both, etc. In another approach, the dimensional conditions of the tape and/or titling state of the modules when the tape was written may be retrieved e.g., from a database, cartridge memory, etc., and the orientation may be set based thereon to about match the transducer pitch of the current operation to that of the previous operation.

In various approaches, additional logic, computer code, commands, etc., or combinations thereof, may be used to control the tape dimensional instability compensation mechanism 1014 for adjusting the orientation of the modules based on a skew of the tape. Moreover, any of the embodiments described and/or suggested herein may be combined with various functional methods, depending on the desired embodiment.

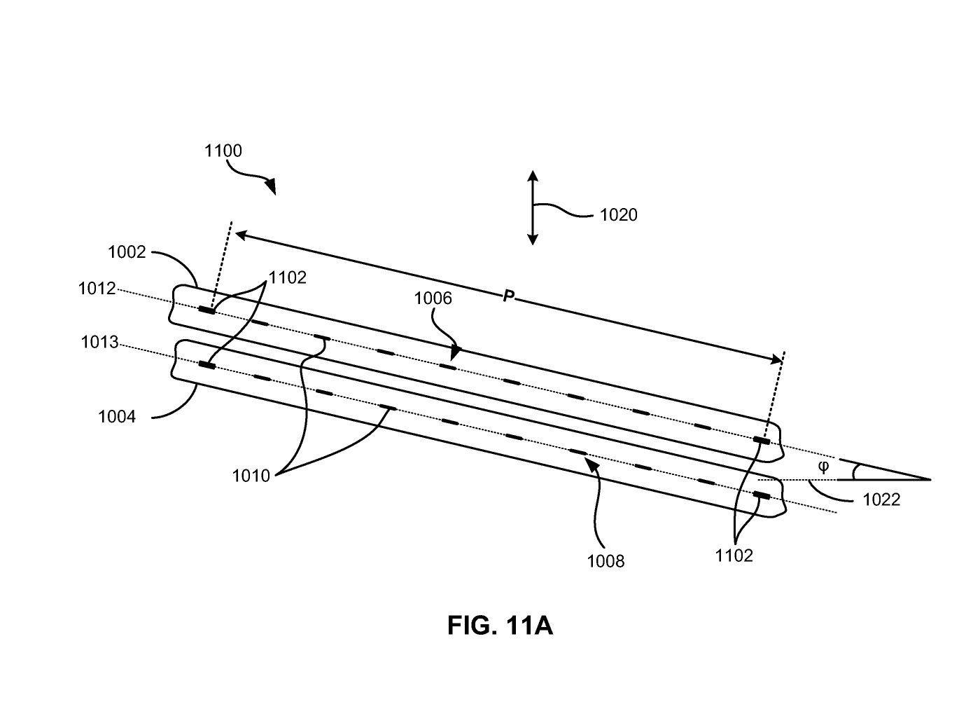

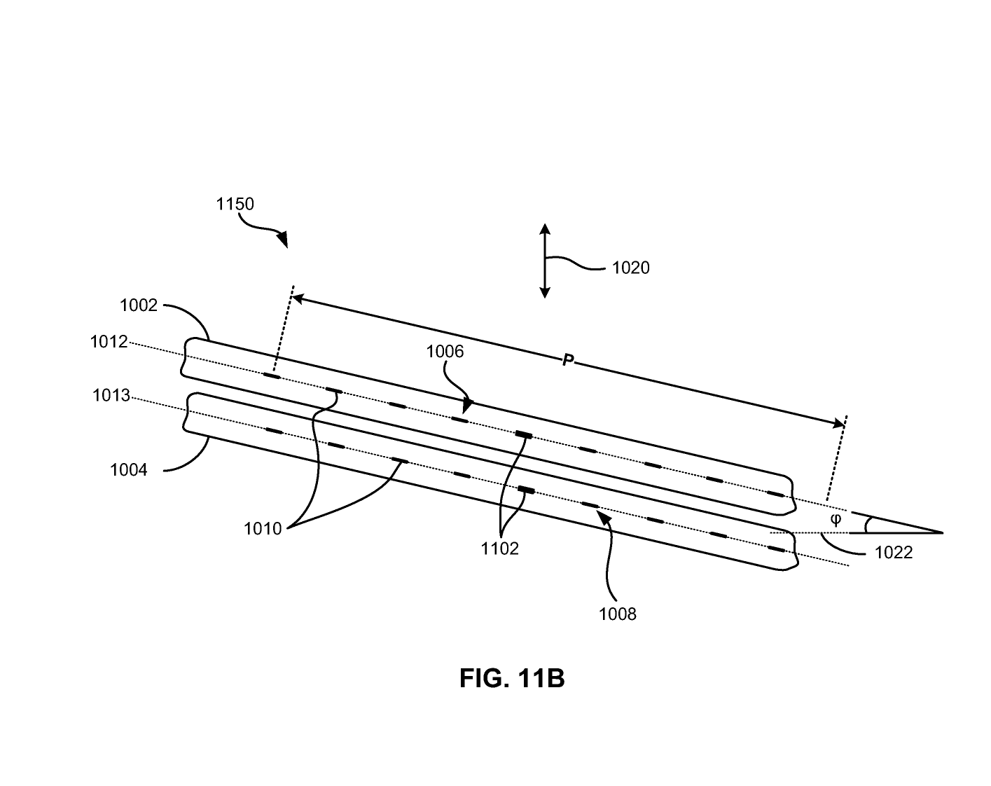

FIG. 11A depicts a system 1100 for compensating for tape lateral expansion and/or contraction, in accordance with one embodiment. The illustrative embodiment depicted in FIG. 11A may be considered a variation of system 1000 of FIG. 10A and therefore includes common numbering to represent common aspects therebetween.

The system 1100 of FIG. 11A, according to an exemplary embodiment, includes at least two modules 1002, 1004, each of the modules 1002, 1004 having an array 1006, 1008 of at least eight transducers 1010 respectively. According to different approaches, the transducers 1010 may be of a particular type selected from a group consisting of data readers and data writers, i.e., at least eight data readers in one of the arrays 1006, 1008, or at least eight data writers in one of the arrays 1006, 1008. Preferably, the at least eight transducers 1010 are included regardless of whether or not another type of transducer is present, e.g., as in a piggyback transducer array, which, according to one example, may have eight data readers and eight data writers. Moreover, one array may have transducers of the data writer type, while the other array may have transducers of the data reader type.

Additionally, each of the modules 1002, 1004 has servo readers 1102 positioned towards opposite ends of the associated array 1006, 1008. According to various approaches, the servo readers 1102 may include any of the approaches described in detail above with reference to the configuration, orientation relative to the tape, etc. of the servo readers 212 of FIG. 2B. With continued reference to FIG. 11A, a centerline span (center to center spacing), referred to herein as the pitch P of the servo readers 1102 of each of the modules 1002, 1004 is at least 28% of a usable width of a tape (not shown) for which the modules 1002, 1004 are designed, i.e., a tape compatible with the drive having the modules. Accordingly, this wide pitch translates to a desirable reduction in the number of data bands for the tape, as will be discussed in further detail below.

Note that the usable width of the tape is definable as that portion of the tape where an average magnetic spacing between the tape and the tape bearing surface of the head of any LTO 6 tape drive during run time is less than 100 nm. The region of the tape within the usable width is deemed usable space. Tape curl at the tape edges during such operation creates the aforementioned magnetic spacing, rendering the edges of the tape unusable for reliable recording.

An axis 1012, 1013 of each array 1006, 1008 is defined between opposite ends thereof, and the axes 1012, 1013 of the arrays 1006, 1008 are nominally oriented about parallel to each other. Moreover, the transducers 1010 of each array 1006, 1008 are spatially arranged along the axis 1012, 1013 of the associated array 1006, 1008 such that adjacent pairs of the same type of transducers 1010 (e.g., the writers) along the axis 1012, 1013 have about a uniform separation therebetween.

With continued reference to FIG. 11A, the array 1006 of a first 1002 of the modules is offset from the array 1008 of a second 1004 of the modules in a first direction parallel to the axis 1013 of the array 1008 of the second module 1004. The array 1006 is preferably offset such that the transducers 1010 of the first module 1002 are about aligned with the transducers 1010 of the second module 1004 in the intended direction of tape travel 1020 thereacross when the axes are oriented at an angle φ (e.g., see FIGS. 9A-9C). In a preferred approach, the angle φ may be between greater than about 0.2° and about 10° relative to a line oriented perpendicular to the intended direction 1020 of tape travel thereacross as illustrated, but may be higher or lower depending on the desired embodiment.

The system 1100 may also include a mechanism (not shown) for setting the angle φ of the modules to control a transducer pitch P presented to a tape. Such mechanism may be of a type known in the art and may include any of the designs described in detail above with reference to the tape dimensional instability compensation mechanism 1014 of FIG. 10B.

Although not shown, the system 1100 of FIG. 11A may also include a controller configured to control the mechanism for orienting the modules 1002, 1004 based on a state of expansion of the tape. Thus, in a preferred approach, the controller may be electrically coupled to the device, e.g., via a wire, cable, bus, etc. According to a number of approaches, the controller may include any of the approaches described in detail above with reference to controller 1016 of FIG. 10B. Moreover, a method for orienting the modules is described below with reference to method 1300.

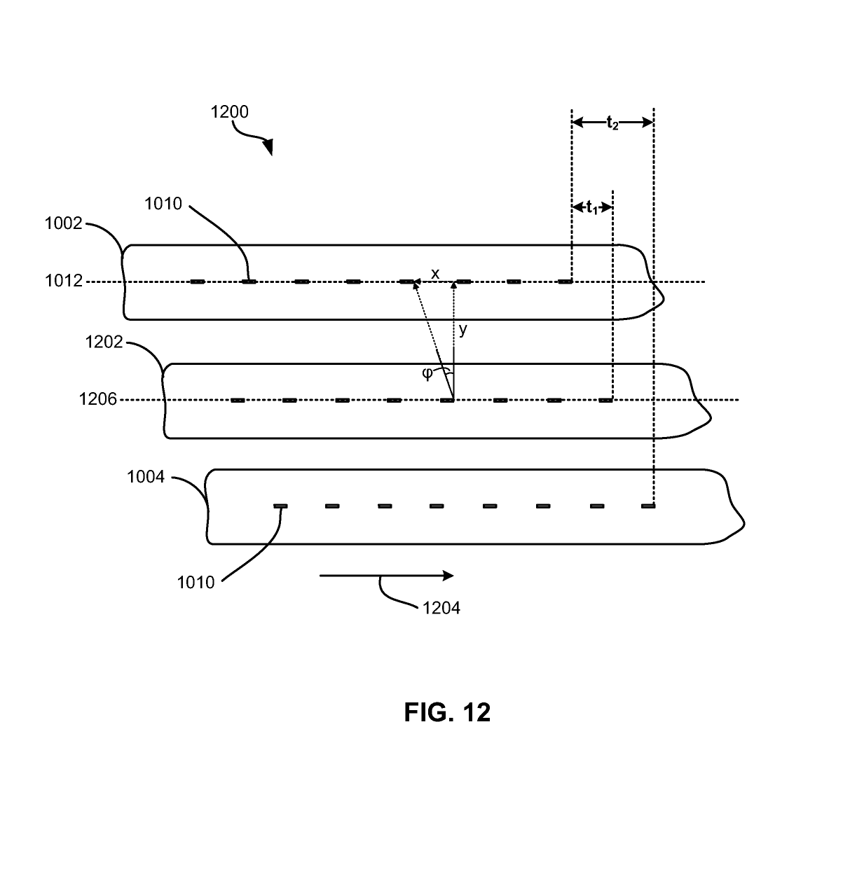

In a preferred approach, only two modules are present, though various embodiments may have three or more modules, e.g., see FIG. 12. In such embodiments having three or more modules, according to some approaches, the multiple modules may have the same or similar configuration to those described and/or suggested herein, depending on the desired design.

Referring again to FIG. 11A, each array 1006, 1008 may have at least sixteen transducers 1010 of the particular type, e.g., readers or writers as described above. However, another approach may have at least thirty two transducers 1010 of the particular type in each array 1006, 1008. In yet another approach, each array 1006, 1008 may have at least sixty four transducers 1010 of the particular type.

Furthermore, contrary to conventional wisdom, the transducers illustrated in FIG. 11A are preferably spaced apart such that the pitch therebetween is widened, which thereby reduces the number of data bands of the head for a given tape, e.g., from those of a normal head. Moreover, a widened pitch as mentioned above may preferably be about 20 μm, more preferably about 30 μm, still more preferably about 40 μm wider than that of a normal head. According to the present description, without wishing to be bound by any theory, a “normal head” may include a ½ inch tape with 4 data bands and a 16 channel head having s transducer pitch of 166.5 μm.

By increasing the transducer pitch and thereby reducing the number of data bands writable on a tape, the mechanism (e.g., the tape dimensional instability compensation mechanism 1014 of FIG. 10B) may make smaller movements to compensate for tape lateral expansion, contraction, skew, etc., than for a “normal head”, thereby resulting in fewer databand switches. Thus, the reduction in databand switches results in less time spent reacquiring servo lock after each data band switch. Additionally, the increased transducer pitch desirably reduces crosstalk on the head as signals from neighboring transducers are reduced by the increased separation therebetween, thereby improving writing and/or reading operations.

Thus, according to one embodiment, the pitch P of the servo readers 1102 of each of the modules 1002, 1004 may preferably be at least 29% of a width of a tape, more preferably at least 40% of a usable width of a tape for which the modules 1002, 1004 are designed. Generally, this pitch allows inclusion of up to two data bands on the tape, however, in another approach, the magnetic recording tape may have no more than three servo tracks written thereon. In another approach, the centerline span of the outermost of the transducers of each of the modules is at least 80% of the usable width of a tape for which the modules are designed.

The tape used with the foregoing system may be of a type known in the art, but modified to be usable with the embodiments described herein. For example, the tape may have a width of about one half inch, but the width in various embodiments may be higher or lower. The following description describes one embodiment of a product having a magnetic recording tape, which is in no way intended to limit the invention.

A product according to one exemplary embodiment includes a magnetic recording tape having N servo tracks written thereon in a longitudinal direction, e.g., about parallel to a longitudinal axis of the tape, or equivalently, about parallel to the tape travel direction. Each servo track may be of a type known in the art, e.g., comprised of a series of magnetically defined bars arranged along the servo track. The magnetic recording tape also has M=N or M=N+1 recordable regions thereon. The recordable regions are defined as usable portions of the tape where user data can be recorded and/or read back. For example, the recordable regions can be defined as those regions not in a servo track and where an average magnetic spacing between the tape and the tape bearing surface of the head of an LTO 6 tape drive during run time is less than 100 nm.

In various approaches, number N of servo tracks is four or less.

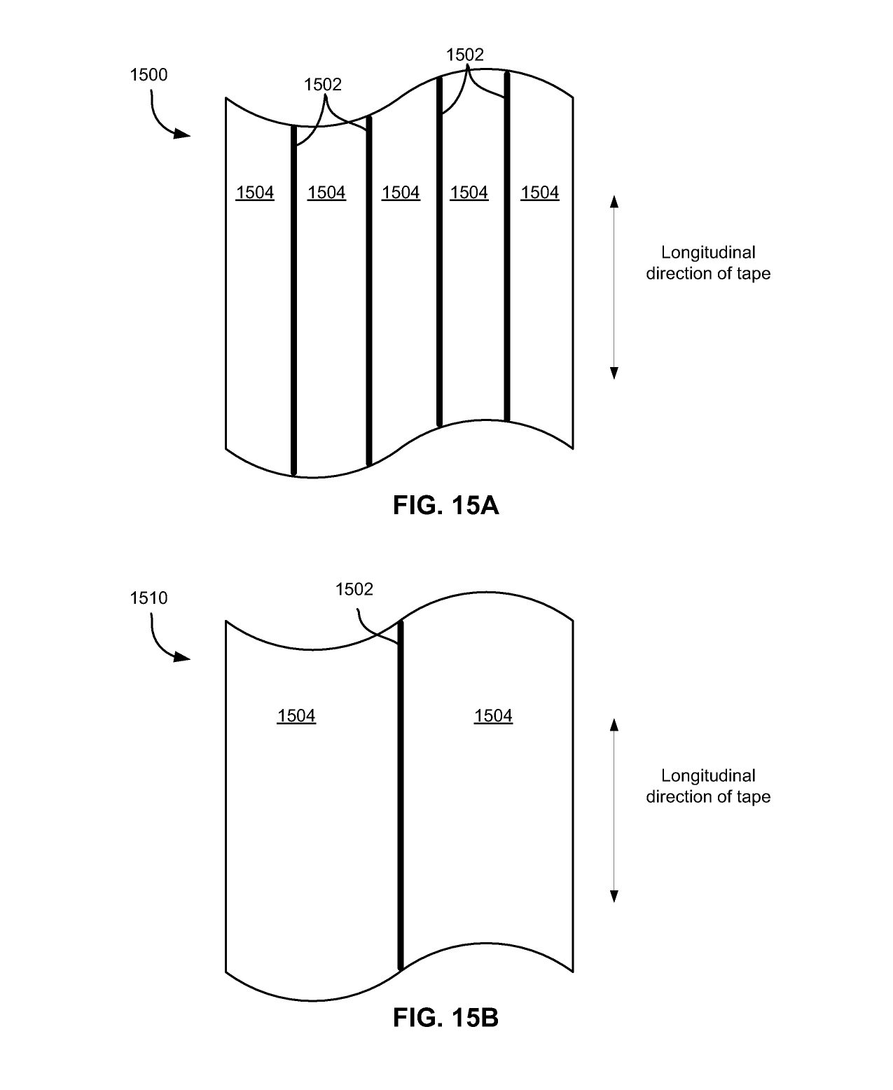

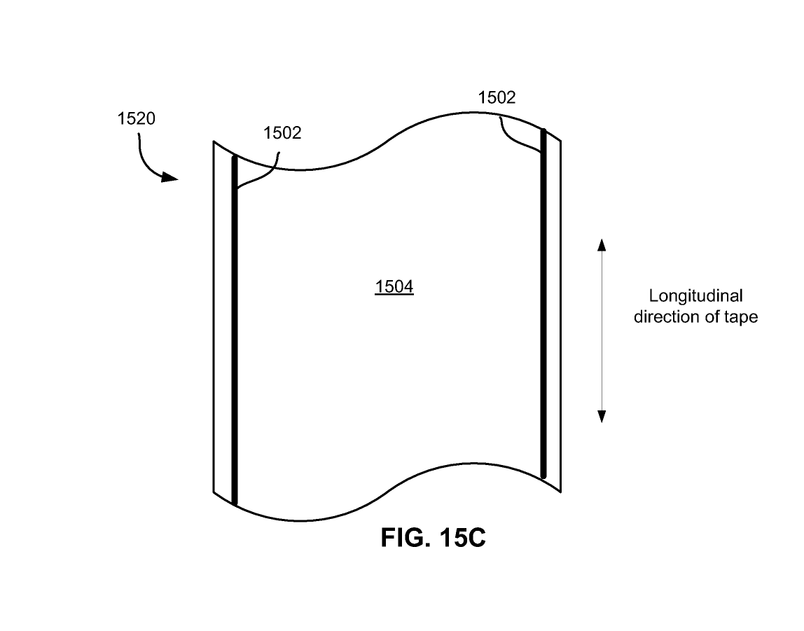

FIG. 15A depicts an embodiment of a magnetic recording tape 1500 where the number N of servo tracks 1502 is four, with M=5 recordable regions 1504.

FIG. 15B depicts an embodiment of a magnetic recording tape 1510 where the number N of servo tracks 1502 is one, with M=2 recordable regions 1504.

In a further approach, the number M of recordable regions of the magnetic recording tape is N−1 when N is an integer less than 5. FIG. 15C depicts such an embodiment of a magnetic recording tape 1520 where the number M of recordable regions 1504 of the magnetic recording tape is N−1 when the number N of servo tracks 1502 is an integer less than 5. In the embodiment shown, N=2.

A product according to another exemplary embodiment includes a magnetic recording tape having at least two, but no more than four servo tracks written thereon. Moreover, according to the present embodiment, the data bands are defined between adjacent pairs of the servo tracks. A recording layer of the magnetic recording tape is physically characterized as enabling writing data tracks with a track width of smaller than 1/255 of a width of the magnetic recording tape. According to various approaches, any suitable type of recording layer known in the art may be used in the magnetic recording tape, such as those presently used for LTO-4 tape cartridges.

According to one approach, the recording layer of the magnetic recording tape may be physically characterized as enabling writing data tracks with a track width of smaller than 1/1055 of the width of the magnetic recording tape.

According to another exemplary embodiment, a system, similar to 1100 of FIG. 11A, may include at least two modules, each of which may have servo readers positioned towards opposite ends of the associated array. Moreover, the pitch (center to center spacing) of the servo readers of each of the modules may be smaller than 10% of a width of a tape for which the modules are designed, i.e., a tape compatible with the drive having the modules. Generally, this pitch would require at least 9 or 10 data bands on the tape. According to another approach, the pitch of the servo readers of each of the modules may be less than 5% of the width of a tape for which the modules are designed.

As a result, the smaller transducer pitch and increased number of data bands resulting therefrom allow for a near perfect cancelation of data miss-tracking. Thus, according to one approach, a combination of orienting the arrays at an angle and smaller data bands as a result of a smaller pitch of the servo readers and/or transducers produces a desirable increase in available area on the tape for storing data thereto.

FIG. 11B depicts an apparatus 1150 that is a variation of the embodiment shown in FIG. 11A, and has common numbering therewith to represent similar components. Referring to FIG. 11B, the servo reader 1102 of each module 1002, 1004 is positioned towards the center of the associated array. A centerline span, or pitch P, of outermost transducers of each of the modules is at least 28% of a usable width of a tape for which the modules are designed.

While the illustrative embodiment of FIG. 11B depicts the servo reader 1102 of each module 1002, 1004 is positioned towards the center of the associated array, the servo reader may be positioned anywhere along the associated array.

Moreover, more than one servo reader may be associated with one or more of the arrays. For example, two or more servo readers may be positioned between lines extending along the outer transducers of any array. In another approach, one or more servo readers may be positioned between lines extending along the outer data transducers of any array, and one or more servo readers may be positioned outside said lines.

In addition, three or more modules may be present.

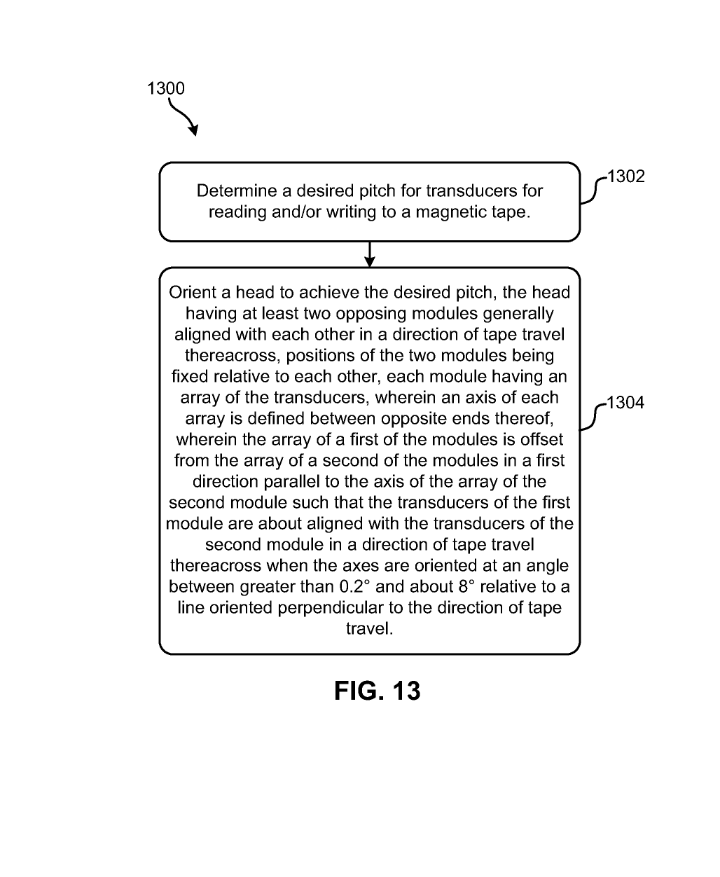

FIG. 13 depicts a method 1300 for orienting modules having transducers, in accordance with one embodiment. Such method 1300 may be implemented by the controller 1016 of FIG. 10B, but is not limited thereto. As an option, the present method 1300 may be implemented in conjunction with features from any other embodiment listed herein, such as those described with reference to the other FIGS. Of course, however, such method 1300 and others presented herein may be used in various applications and/or in permutations which may or may not be specifically described in the illustrative embodiments listed herein. Further, the method 1300 presented herein may be used in any desired environment.

Referring now to FIG. 13, the method 1300 includes determining a desired pitch for transducers for reading and/or writing to a magnetic tape as illustrated in operation 1302. By determining a desired pitch for the transducers, the modules may effectively compensate for any tape expansion, contraction, skew, etc. as demonstrated in FIGS. 9A-9C.

In one approach, the desired pitch may be determined by the state of the tape. An exemplary mechanism for establishing the proper pitch is to use the timing interval read by two servo readers to determine the state of the tape, e.g., contracted, expanded or nominal. Although a preferred mode is to use servo data, this is not absolutely required. Thus, it may be desirable to determine the state of the tape, e.g., by incorporating any of the approaches described and/or suggested herein and/or known processes, when determining the desired pitch. However, according to other approaches, the pitch may be determined using any approach described and/or suggested herein, or combinations thereof.

Method 1300 further includes orienting a head to achieve the desired pitch, the head having at least two opposing modules generally aligned with each other in a(n intended) direction of tape travel thereacross, positions of the two modules being fixed relative to each other, each module having an array of the transducers, where an axis of each array is defined between opposite ends thereof, where the array of a first of the modules is offset from the array of a second of the modules in a first direction parallel to the axis of the array of the second module such that the transducers of the first module are about aligned with the transducers of the second module in a direction of tape travel thereacross when the axes are oriented at an angle between greater than 0.2° and about 10° relative to a line oriented perpendicular to the direction of tape travel. See operation 1304.

In one approach, steps 1302 and 1304 may be performed concurrently. For example, in one embodiment the proper transducer pitch may be based on data signals. One way to implement this is by first setting the transducer pitch at a nominal value by selecting a nominal angle of orientation, and then adjusting the orientation thereof to obtain a better readback quality across the read channels. The quality may be determined for example by finding the lowest error rate, best signal to noise level, etc.

As an option, the system may continue or periodically monitor the appropriate signals and adjust the angle of orientation. Adjustments can be performed any time, such as during an initialization period prior to reading or writing user data, during readback or writing operations, etc.

Although two modules 1002, 1004 are illustrated in FIGS. 10A-11, in other approaches, a system may include any number of modules e.g., at least two, at least three, at least four, a plurality, etc. depending on the desired embodiment. Referring to the illustrative embodiment depicted in FIG. 12, which may be considered a modification of system 1000 of FIG. 10A and therefore includes common numbering therewith, the system 1200 shown may include a third module 1202 positioned between the first and second modules 1002, 1004. As shown, the array of transducers of the third module 1202 is preferably offset from the array of the first module 1002 in a first direction 1204. Moreover, the extent of the offset t₁ of the array of the third module 1202 relative to the array of the first module 1002 is less than an extent of the offset t₂ of the array of the second module 1004 relative to the array of the first module 1002.

According to different approaches, the first second and/or third modules 1002, 1004, 1202 may be used for data writing and/or data reading, depending on the desired embodiment. Thus, the system 1200 may serve as a write-read-write (WRW) device if the first and second modules 1002, 1004 are designed for at least data writing and the third module 1202 is designed for at least data reading. As an option, the first and second modules 1002, 1004 may be designed for data writing and not for data reading, and/or the third module 1202 maybe designed for data reading and not for data writing.

In another approach, the system 1200 may serve as a read-write-read (RWR) device if the first and second modules 1002, 1004 are designed for at least data reading and optionally not for data writing, while the third module 1202 is designed for at least data writing and optionally not for data reading. However, this is in no way meant to limit the invention; according to various other approaches, a third, fourth, fifth, etc. module may be positioned with any orientation relative to other modules of the system, depending on the desired embodiment.

With continued reference to FIG. 12, according to one approach, the angle of orientation φ of the modules 1002, 1202, 1004 and distance y between the arrays may be used to calculate the offset x. As illustrated, the offset x is between the arrays of transducers of the modules in a direction parallel to their axes 1012, 1206, which may be calculated using Equation 1.

tan(φ)=x/y Equation 1

Equation 1 can be rewritten into Equation 2.

y(tan(φ))=x Equation 2

Other known methods of calculating and/or assigning the offset x and distance y between the arrays of any of the modules may be used in other embodiments.

According to other approaches, a three module head may also allow for non-serpentine and/or serpentine writing. Referring still to FIG. 12, according to another illustrative approach, the modules 1002, 1202, 1004 may have a RWR configuration (e.g., the data transducers 1010 of the first and second modules 1002, 1004 may include readers, wherein the data transducers of the third array 1202 may include writers). Using a RWR configuration for a three module head allows for non-serpentine writing, whereby the same writer array writes each adjoining data track, despite reversal of the tape direction while writing thereto. This may reduce writing errors, readback errors, data loss, etc., as well as reducing the misregistration budgeting requirements, as only one set of track tolerances comes into play. Moreover, using the same writer array to write adjoining data tracks ensures consistency while writing (e.g., by enabling symmetrical servo pattern reading), overall higher areal density, etc.

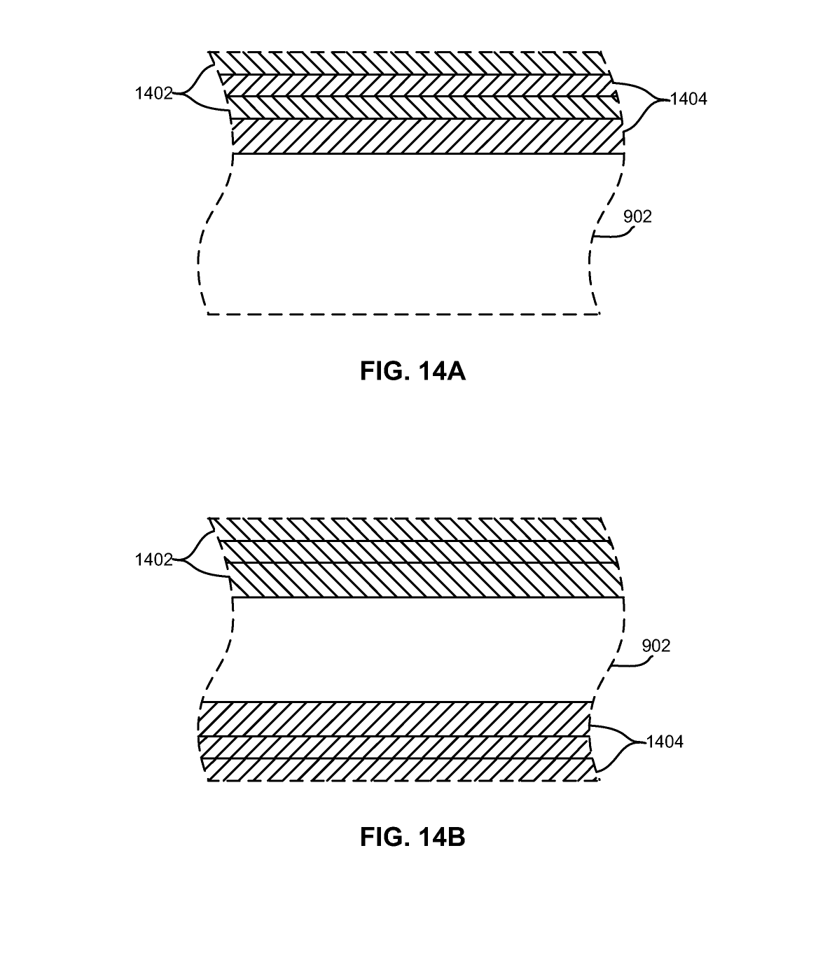

Thus, as illustrated in the representational diagram of FIG. 14A, which is in no way intended to limit the invention, the angles or orientation of the magnetic transitions on the tape 902 may be different such that the magnetic transitions written in the shingled data tracks 1402 in one direction are at a different angle than the magnetic transitions in shingled data tracks 1404 written in the opposite direction. Moreover, when reading a data track, the reader array may be oriented to about match the angle of the written transitions of each shingled data track to read the data thereon. Thus, if the reader array drifts over one of the adjacent data tracks, the off-track reading rejection SNR is reduced, because the angle of orientation of the magnetic transitions on the adjacent data track will not match the angle of orientation of the read array.

Note that, while not ideal, a WRW configuration could be used for non-serpentine writing in some approaches.

Referring again to FIG. 12, according to another illustrative approach, the modules 1002, 1202, 1004 may have a WRW configuration (e.g., the data transducers 1010 of the first and second modules 1002, 1004 may include writers, wherein the data transducers of the third array 1202 may include readers), for conducting serpentine writing. While writing data with a WRW configuration, the leading writer and reader may preferably be active, while the trailing writer is not active, depending on the intended direction of tape travel. As a result, the leading writer array may be used to write adjoining data tracks for one direction of tape travel, while the trailing writer array may be used to write adjoining data tracks for the other direction of tape travel.

Thus, as illustrated in the representational diagram of FIG. 14B, which is in no way intended to limit the invention, the angles of orientation of the magnetic transitions on the tape 902 may be about the same for shingled data tracks 1402 written in a first direction of tape travel, but different than the angles of orientation of the magnetic transitions in the shingled data tracks 1404 written during the opposite direction of tape travel. This preferably reduces writing errors, readback errors, data loss, etc. and ensures consistency while writing, e.g., by enabling symmetrical servo pattern reading.

According to yet another approach, the arrays may have a RWR configuration as described above, for conducting serpentine writing. While writing data with a RWR configuration, the writer and corresponding trailing reader may preferably be active, while the leading reader is not active, depending on the direction of tape travel. As a result, the same writer may be used to write each adjoining data track for both directions of tape travel, despite reversal thereof while writing.

It will be clear that the various features of the foregoing systems and/or methodologies may be combined in any way, creating a plurality of combinations from the descriptions presented above.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as “logic,” a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a non-transitory computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer readable storage medium include the following: a portable computer diskette, a hard disk, a random access memory (RAM), a read-only memory (ROM), an erasable programmable read-only memory (EPROM or Flash memory), a portable compact disc read-only memory (e.g., CD-ROM), a Blu-ray disc read-only memory (BD-ROM), an optical storage device, a magnetic storage device, or any suitable combination of the foregoing. In the context of this document, a non-transitory computer readable storage medium may be any tangible medium that is capable of containing, or storing a program or application for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a non-transitory computer readable storage medium and that can communicate, propagate, or transport a program for use by or in connection with an instruction execution system, apparatus, or device, such as an electrical connection having one or more wires, an optical fibre, etc.

Program code embodied on a computer readable medium may be transmitted using any appropriate medium, including but not limited to wireless, wireline, optical fibre cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer, for example through the Internet using an Internet Service Provider (ISP).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart(s) and/or block diagram block or blocks.

It will be further appreciated that embodiments of the present invention may be provided in the form of a service deployed on behalf of a customer.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. An apparatus, comprising:
at least two modules,
each of the modules having an array of transducers of a particular type selected from a group consisting of data readers and data writers,
each of the modules having at least one servo reader,
wherein a centerline span of outermost transducers of each of the modules is at least 28% of a usable width of a tape for which the modules are designed,
wherein an axis of each array is defined between opposite ends thereof,
wherein the axes of the arrays are nominally oriented about parallel to each other,
wherein the transducers of each array are spatially arranged along the axis of the associated array such that adjacent pairs of the transducers along the axis have about a uniform separation,
wherein the array of a first of the modules is offset from the array of a second of the modules in a first direction parallel to the axis of the array of the second module such that the transducers of the first module are about aligned with the transducers of the second module in an intended direction of tape travel thereacross when the axes are oriented at an angle between greater than 0.2° relative to a line oriented perpendicular to the intended direction of tape travel thereacross; and
a mechanism for orienting the modules to control a transducer pitch presented to a tape.

2. An apparatus as recited in claim 1, wherein only two modules are present.

3. An apparatus as recited in claim 1, wherein three or more modules are present.

4. An apparatus as recited in claim 1, wherein each array has at least eight transducers of the particular type.

5. An apparatus as recited in claim 1, wherein the centerline span of the outermost of the transducers of each of the modules is at least 40% of the usable width of a tape for which the modules are designed.

6. An apparatus as recited in claim 1, wherein the centerline span of the outermost of the transducers of each of the modules is at least 80% of the usable width of a tape for which the modules are designed.

7. An apparatus as recited in claim 1, wherein the tape has a width of about one half inch.

8. An apparatus as recited in claim 1, further comprising a controller configured to control the mechanism for orienting the modules based on a state of expansion of the tape.

9. A product, comprising:
a magnetic recording tape having N servo tracks written thereon in a longitudinal direction,
the magnetic recording tape having M=N or M=N+1 recordable regions thereon, or
the magnetic recording tape having M=N−1 recordable regions thereon when N is an integer less than 5.

10. A product as recited in claim 9, wherein N≦4.

11. A product as recited in claim 9, wherein N≦3.

12. A product as recited in claim 9, wherein N=1.

13. A product as recited in claim 9, wherein M=N or M=N+1.

14. A product as recited in claim 9, wherein M=N−1 and N is the integer less than 5.

15. An apparatus, comprising:
at least two modules,
each of the modules having an array of at least eight transducers selected from a group consisting of data readers and data writers,
each of the modules has at least one servo reader,
wherein a centerline span of outermost transducers of each array is smaller than 10% of a width of a tape for which the modules are designed,
wherein an axis of each array is defined between opposite ends thereof,
wherein the axes of the arrays are nominally oriented about parallel to each other,
wherein the transducers of each array are spatially arranged along the axis of the associated array such that adjacent pairs of the transducers along the axis have about a uniform separation,
wherein the array of a first of the modules is offset from the array of a second of the modules in a first direction parallel to the axis of the array of the second module such that the transducers of the first module are about aligned with the transducers of the second module in an intended direction of tape travel thereacross when the axes are oriented at an angle greater than 0.2° relative to a line oriented perpendicular to the intended direction of tape travel thereacross; and
a mechanism for orienting the modules to control a transducer pitch presented to a tape.

16. An apparatus as recited in claim 15, wherein only two modules are present.

17. An apparatus as recited in claim 15, wherein each array has at least sixteen transducers.

18. An apparatus as recited in claim 15, wherein the centerline span of the outermost of the transducers of each of the modules is less than 5% of the width of a tape for which the modules are designed.

19. An apparatus as recited in claim 15, wherein the tape has a width of about one half inch.

20. An apparatus as recited in claim 15, further comprising a controller configured to control the mechanism for orienting the modules based on a state of expansion of the tape.
